(19) United States
(12) Patent Application Publication
(10) Pub. No.: US 2008/0311968 A1
(43) Pub. Date: Dec. 18, 2008

(54) METHOD FOR IMPROVING SELF-MANAGEMENT OF A DISEASE

(76) Inventor: Thomas C. Hunter, Marblehead, MA (US)

Correspondence Address: CLOCK TOWER LAW GROUP, 2 CLOCK TOWER PLACE, SUITE 255, MAYNARD, MA, 01754-2545, US

(21) Appl. No.: 11/762,506

(22) Filed: Jun. 13, 2007

(51) Int. Cl. A63F 13/00

(52) U.S. Cl. 463/1

(57) ABSTRACT

The invention includes an interactive method of therapy for disease management, and for improving self-management of diabetes and other medical conditions. The invention improves quality of life for users with a medical condition, and decreases the over all cost of health care for insurers. Operation of the invention promotes therapeutic behavioral change and substantial increase in adherence to disease self-management programs. In one embodiment, the invention uses a video game to improve self-management of a disease. Games used with the invention provide one or more reinforcements to players who wish to change their behaviors in a way that improves their chronic disease condition. Reinforcements consist of token rewards, prizes, increasing scores, group approval or disapproval, and increased social status. A video game accesses medical data of a player. The video game prompts players to perform one or more out-of-game self-management activities associated with the medical condition. The invention then adjusts the video game based on medical data associated with one or more out-of-game self-management activities. In-game and out-of-game rewards, including social rewards, provide incentives to continue with a self-management program.

### CROSS-REFERENCE TO RELATED APPLICATIONS

None.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. Copyright 2007 Compass Rose Games.

### BACKGROUND OF THE INVENTION

1. Field of the Invention

The invention relates to single and multiplayer computer games played online using a computer, cell phone, game console or similar device, and relates particularly to games used for therapeutic purposes to assist individuals with diseases in the management of those diseases.

2. Background

Diabetes is a well known metabolic disease characterized by improper control of sugar in the blood because the body does not produce enough insulin, or properly use insulin, to maintain safe blood sugar levels. Blood sugar levels are determined by measuring blood glucose at a given point in time. High blood sugar levels lead to many complications including blindness, stroke, nerve damage, amputation of the lower limbs, kidney failure, and heart attack. The overall risk of dying among people with diabetes is at least double the risk of their peers without diabetes.

Diabetes is reaching epidemic proportions in the developed world. More than 171 million people worldwide have diabetes, and this number is likely to more than double by 2030. In Canada, the number of diabetics is expected to increase from 2 million to 3.5 million between 2000 and 2030; in the US from 17 million to 30 million; in Australia from just fewer than 1 million to over 1.6 million. Similar increases are expected all over the industrialized and newly industrializing world.

The cost of diabetes is very large and growing rapidly. In the United States, the health care cost for treating diabetes and related complications is over ten thousand dollars annually per symptomatic diabetic. Total US expenditure on diabetes is estimated at $123 billion as of 2005.

To prevent the complications of diabetes, diabetics must manage their disease. Diabetes responds well to management, and successful management of the disease can help diabetics live long, happy, and productive lives. Unmanaged or poorly managed diabetes, however, leads to serious complications. By adopting certain healthy behaviors and avoiding unhealthy behaviors, diabetics can avoid many of these complications.

3. Description of Prior Art

Current diabetes management strategies focus on education to drive behavioral change. Diabetes Self-Management Education (DSME) is a technique that involves the diabetic learning the skills needed to manage his/her diabetes and control his/her blood sugar level daily. DSME is a preventive care solution that can help manage diabetes-related complications and reduce overall health costs. Existing diabetes management strategies recognize the need for regular contact, community support, encouragement, and regular monitoring. Most efforts support preventive care with weekly, monthly, or even less frequent contact because frequent contact requires the time of expensive medical professionals. Other methods of controlling diabetes include medication, community health programs, and Internet-based programs to help people manage diabetes. In addition, there are several games designed for young people with diabetes.

Nevertheless, there is a serious problem with DSME. As a group, diabetics do not adhere well to regimented programs. Furthermore, methods that have proven to be effective in increasing patient adherence to diabetes management programs do not reach all patients. In fact, existing programs achieve effective self-management (defined as an Hb_{A1C} (glycosylated hemoglobin) level of 6.5 mmol/L) in only 10-15% of diabetics. Thus, the majority of diabetics to not adequately adhere to diabetes management programs or fail at self-management. Existing programs do not fully meet the needs of these patients. Therefore additional ways to encourage self-management are needed.

Education can help increase the percentage of diabetics who successfully perform self-management, and community involvement can help increase the success rate. Existing methods rely in part on knowledge of behavioral change to help patients manage diabetes. If the medical community is using behavioral change to help diabetics, then it behooves the medical community to look at all possible ways of causing and reinforcing these behavioral changes, especially those that offer increases in efficacy and reduction in cost through innovative use of technology.

Games have been proven to drive a change in behavior. Recently a number of games that produce positive therapeutic impact have proven to be effective in a peer-review-study environment. Examples include the following.

“Re-Mission” was developed by HopeLab (www.hopelab.org, www.re-mission.net) for adolescent cancer patients to help improve outcomes by driving positive behavioral change in the areas of compliance with medication, reporting symptoms, and self-efficacy.

“RoboMemo” was developed by Cogmed (www.cogmed.com) to help people with ADHD improve their working memories. Studies have shown improvement for children with ADHD with behavioral change driven by repeated playing of a computer game designed for that purpose.

“Packy and Marlon” was developed in the mid-1990s by Click Health (now defunct) for young people with diabetes. Packy and Marlon was successful in educational and behavioral modification goals, causing a 77% reduction in diabetes-related emergency and urgent care clinical visits.

Thus, games can be designed in a way to cause behavioral change that can be verified in a clinical setting, and these changes can have substantial therapeutic benefits for patients.

Diabetes management could be substantially improved with the assistance of a properly designed game. For some diabetic patients, a dramatic improvement in behavior, health, and cost of treating the disease will result.

Games can be classified as either games for entertainment or serious games. See, for example, Social Impact Games (www.socialimpactgames.com), a community resource for all those interested in games with non-entertainment goals. Serious games are games that have a purpose beyond entertaining the player. For example, “America's Army” (www.americasarmy.com) is used as a recruiting tool by the US Army, and it is also used for training purposes within the Army. Another type of serious game is therapeutic games. For example, Cogmed's “Working Memory Training” game has been shown to help children with attention deficits.

Serious games are designed to achieve a goal outside of the play of the game. “America's Army” tries to make soldiers better at their job, “Working Memory Training” helps people with attention deficits, and Re-Mission educates children with cancer about their disease and helps them cope with the side effects of their cancer. Soldiers, people with attention deficit, and children with cancer may enjoy playing their respective games, but the ultimate goals are, respectively, improved competency, improved memory, and improved quality of life for the cancer patient, not simply entertainment for a given period of time.

There are a number of publications that describe attempts to improve diabetes management education.

“Longitudinal Outcomes of a Diabetes Self-Management Program Via Telehealth,” Susan L. Dimmick, et al., describes a diabetes management study. On a daily basis, patient blood sugars were stored and forwarded to a proprietary software program that charted daily, weekly, and monthly trends. Patients could see a pie chart of their blood sugar levels to show their level of control after each meal and for a given day. The study showed that 37 of 56 patients (66%) showed a decline in Hb_{A1C} levels, showing better glycemic control over time.

Dimmick indicates that intensive self-monitoring and telehealth oversight have a positive impact on diabetes management. Telehealth, also called telemedicine, is a connection between patient and clinician via a telephone network, the Internet, a wireless device or any other similar device. Telehealth allows a clinician to talk to a patient or to view data about a patient, or both, and then make recommendations about care based on the conversation and data. This communication system, however, was for reporting only. The reporting system did not include automated education or community features. Although behavioral change was both a goal and an outcome, this communication system was not designed to foster behavioral change.

“Establishment of Blood Glucose Monitoring System Using the Internet and Long-Term Effect of the Internet-Based Glucose Monitoring System on Hb_{A1C} Reduction and Glucose Stability,” Jae-Hyoung Cho, et al., shows short and long term benefits to intensive diabetes management using Internet-based tools. Hb_{A1C} levels in the intervention group declined over the life of the trial, which involved Internet-based glucose monitoring and frequent contact and monitoring by a staff of clinicians. The trial, however, did not use any automated processes with the Internet-based glucose monitoring. Internet-based glucose monitoring was only used to facilitate communication between patients and the clinical team. Failure to automate education, community, and medical functions meant that this program required a staff of 5 to support 40 patients participating in the intervention.

“Glucoweb: A Case Study of Secure, Remote Biomonitoring and Communication,” Daniel J. Nigrin and Isaac S. Kohane, shows a secure system for diabetes management with Internet-based communication between patients and clinicians. Glucoweb (web.archive.org/*/www.glucoweb.net) addresses security and functionality issues. Glucoweb shows a diabetes management system and discusses methods for keeping the data secure. Glucoweb does not discuss the benefits of automation, and IT is primarily concerned with secure communication. As in previous example, patients benefit from more intensive monitoring, but Glucoweb is designed to get results by improving communication between patient and clinician.

“Educational Video Game For Juvenile Diabetes: Results Of A Controlled Trial,” Brown, et al., details a diabetes study. Brown found that an intervention group reported improvement of various aspects of diabetes management, and the intervention group had a reduced number of emergency room and critical care visits compared to a control group. The game, however, was not connected to the Internet, did not have any community features, and did not report data relating to diabetes management to clinicians, to the diabetics themselves, or to the parents.

“Web-Based Care Management In Patients With Poorly Controlled Diabetes Mellitus,” McMahon, et al., showed that intensive diabetes management with web-based monitoring and education programs can improve Hb_{A1C} levels. However, there were no community features or motivational features to the program. Also, the educational component was static, i.e., it did not adapt itself based on actions taken and data input by the patient. No incentives were provided to the patients to better manage their diabetes.

“Reduction In The Incidence Of Type 2 Diabetes With Lifestyle Intervention or Metformin,” Rockville, describes a diabetes prevention program research group. Rockville shows that lifestyle intervention can substantially reduce the incidence of diabetes in populations that are at a high risk of contracting the disease. However, no attempts to automate the lifestyle intervention were made; the program relied entirely on human intervention.

U.S. Patent Application Publication 2006/0105825 (May 18, 2006, Findlay) titled “Game For Educating Users Regarding Medical Conditions,” discloses a game for teaching about conditions affecting the human body. Findlay discloses a video game apparatus, a method of doing battle with medical conditions that adversely affect the human body, and a video game medium therefore. Findlay does not address behavioral change, multiplayer game play, issues of community, or tie the game to actual medical data outside the game.

U.S. Patent Application Publication 2006/0094947 (May 4, 2006, Kovatchev) titled “Method, System, And Computer Program Product For The Evaluation Of Glycemic Control In Diabetes From Self-Monitoring Data,” discloses a method for evaluating the long term probability for severe hypoglycemia of a patient. Kovatchev attempts to predict the long-term risk of hyperglycemia, and the long-term and short-term risks of severe hypoglycemia in diabetics, based on blood glucose readings collected by a self-monitoring blood glucose device. Kovatchev does not address games, nor does Kovatchev address behavioral change directly. Kovatchev is directed at improving risk assessment in order to improve outcomes, by informing diabetics and/or their care providers when they are at risk of adverse events relating to hyperglycemia and hypoglycemia. Kovatchev focuses on one specific problem faced by diabetics, but Kovatchev does not address the full range of behaviors and obstacles involved for those who face the disease.

U.S. Patent Application Publication 2005/0287502 (Dec. 29, 2005, Southard) titled “Health Maintenance System For Children,” discloses a method for preventing and treating childhood obesity involving parental or guardian involvement. Southard uses a personal computer of a child to attempt to modify behavior to improve a child's diet and exercise program. Inputs are defined by parents, and the reward is access to a computer game. Southard, however, does not disclose a game to be motivational by itself, does not address automating input of outside measures, and Southard does not provide auditing measures to control false reporting. Southard neither builds motivation into the game play nor adjusts game play based on data entered from outside the game.

U.S. Patent Application Publication 2005/0250995 (Nov. 10, 2005, Quy) titled “Method And Apparatus For Health And Disease Management Combining Patient Data Monitoring With Wireless Internet Connectivity,” discloses an Internet-enabled device to monitor health. Quy combines patient data monitoring with wireless Internet connectivity for a health and disease management device. Quy address the issue of getting data from a patient to a central database over the Internet, which, if properly used, can greatly facilitate patient care. Quy also discloses partially automating patient care with processes. Quy does not address motivation and behavioral change and is not focused on driving better patient outcomes.

U.S. Patent Application Publication 2005/0117527 (Jun. 2, 2005, Williams) titled “Use Of A Closed Communication Service For Social Support Networks To Diagnose And Treat Conditions In Subjects,” discloses a communication network to stimulate communication among caregivers and patients. Williams attempts to reduce social isolation experienced by people with diseases, such as Alzheimer's, depression, or cancer, by facilitating communication between the patient and their care givers. Williams does not include motivational factors, does not attempt to drive behavioral change, and does not track medical conditions.

U.S. Patent Application Publication 2007/0015569 (Jan. 18, 2007, Norton) titled “Real Time Marketing At Gaming Machines,” discloses a method for providing real-time incentives to players at a gaming machine in a casino establishment. Norton attempts to provide incentive to players at a gaming machine in order to cause players to remain at the casino or return to the casino more often. Norton does not address data from outside the game. Norton describes an attempt to monitor game players inside a casino and provide rewards using information technology to automate a process that is currently carried out by casino employees.

U.S. Patent Application Publication 20040180708 (Sep. 16, 2004, Southard), titled “Health Based Internet Game For Children,” discloses a method of teaching good health habits using an Internet-based adventure game program. Southard encourages healthy behavior through gameplay and by tying some aspects of game play to exercise measures that are recorded by a device outside the game. Southard requires parental involvement, and the game is aimed at children ages nine to eleven years old.

U.S. Pat. No. 5,307,263 (Apr. 26,1994, Brown), titled “Modular Microprocessor-Based Health Monitoring System,” discloses a self-care health monitoring device. Brown uses a modular microprocessor based health monitoring system tied to a Nintendo Game Boy or similar platform. Brown makes collection, storage, and forwarding of data used in diabetes self management easier for the patient and the care provider. Brown, however, does not teach behavioral change, community involvement, education, or other motivators for behavioral change. Brown does not involve or make use of games themselves, but uses a game controller as a device for monitoring certain measures that are needed for effective diabetes self management.

U.S. Pat. No. 5,730,654 (Mar. 24, 1998, Brown), titled “Multi-Player Video Game For Health Education,” discloses a video game to provide health education and encourage communication. Brown is designed to educate young people about health conditions and healthy habits using a multiplayer environment to drive discussion outside the game. The game has multiplayer features but does not include Internet play. The invention is designed to educate and uses community motivators for a target audience of children and their parents. The primary goal of Brown is limited to education. Brown does not build a wider Internet-based community of users. Brown does not use additional motivators available to larger communities, nor does it use team play and outside factors to drive behavioral change. Brown also does not include a structure of prizes associated with the game to support behavioral change.

U.S. Pat. No. 6,279,908 (Aug. 28, 2001, Hunsberger), titled “Diabetes Mellitus Game,” discloses a board game to educate players about diabetes using questions and answers. Hunsberger is not electronic and is not focused on adult diabetics.

U.S. Pat. No. 6,151,586 (Nov. 21, 2000, Brown) is titled “Computerized Reward System For Encouraging Participation In A Health Management Program.” Brown describes a reward system based entirely on compliance with a medical regimen. Rewards included credits to data cards and personal accounts at retail stores. There are no rewards designed to appeal to social or competitive motivational factors. Rewards are linear in a pay-for-performance system.

None of the methods listed above provides a method of diabetes self management that gives the user multiple motivations to change their behavior in ways that improve diabetes self management, reduce over all cost of care, and improve patient outcomes. The methods above do not provide an automated system that responds to patient provided data inputs with education or incentives to help with better self management.

Some of the methods above rely heavily on clinicians for their success, rather than using automated tools. This makes them impractical to implement on a large scale because of the cost. Other methods above do not involve intensive diabetes management. These methods fail to benefit from frequent contact with a patient. Infrequent patient contact helps control costs but reduces the efficacy of care.

The methods above with community support are limited by geographic and time constraints. None of the methods above provides community support based on preferences expressed by the diabetics themselves, and none uses the Internet to connect diabetics with common interests. The methods above have rewards systems that are not sophisticated and do not have social impact and/or impact on team play. None of the methods above provides a game focused on diabetes and designed to encourage players to play the game and manage their disease on a daily basis.

### BRIEF SUMMARY OF THE INVENTION

The invention includes an interactive therapy for diabetes management. Diabetes patients access an online community formed around a common interest in games. These games and the community features are designed to motivate positive behavioral change in type II diabetics with incentives including, but not limited to, education, competition, team play, and the thrill of victory and prizes. The invention improves medical outcomes for patients and decreases the over all cost of diabetes for insurers. The invention includes a game provided through a monthly subscription fee paid by insurers. The operation of the invention causes therapeutic behavioral change and substantial increase in adherence to diabetes self-management, saving significant sums in healthcare costs and, more importantly, giving many people longer, healthier, happier lives.

The games use multiple methods to provide reinforcement(s) to players who wish to change their behaviors in a way that improves their chronic disease condition. Reinforcement(s) consist of token rewards, prizes, increasing scores, group approval/disapproval, and increased social status. In addition, the games are designed to increase self-efficacy to help enable behavioral change. The invention uses an underlying computerized process of diabetes care to drive game play, and applies intensive diabetes management techniques to players. The invention enables the linking of game play and the underlying diabetes management process, so that achieving short term game goals is facilitated by achieving short and long term diabetes management goals.

In one embodiment, the invention is a method for improving self-management of a medical condition. In this embodiment, the invention provides a video game which is electronically accessible to one or more participants. The video game can be provided on a client-server model, a home-based video game system, cell phone, or any other means of providing video games. The video game can have predefined rules and one or more game objectives. The video game is designed for use by one or more participants having a medical condition. A medical condition means, broadly, any condition, suffered by a person, which condition can be helped, in any measure, by self-management activities. Such conditions can include diabetes, alcoholism, anger control, heart disease, depression, high blood pressure, asthma, chronic rheumatic conditions, and so forth.

Upon beginning a game or logging in to a game, the video game accesses medical data of the participant. This medical data can include data that the participant submitted that relates to self-management of the medical condition. This data can be historical data from previous game sessions. The video game prompts participants to perform one or more out-of-game self-management activities associated with the medical condition. For example, when the medical condition is diabetes, the activity may include entering blood glucose levels, exercising, eating a meal with a low glycemic index, complying with medication, etc. The video game provides an interface or displays a dialog box for receiving medical data associated with the out-of-game self-management activity. Entering out-of-game data can be facilitated with electronic devices such as a glucometer or pedometer that connects to the video game either wirelessly or through a USB connection.

The invention then adjusts the video game based on medical data associated with one or more out-of-game self-management activities. Adjusting the video game means changing any variable associated with the video game or with video game play. This includes adjusting a score (positively or negatively), adjusting a player's lives, abilities, or powers, adjusting a player's position or location within a game, adjusting game rules or game objectives. Based on the out-of-game submitted data, the game can suggest lower calorie recipes for a player who is gaining weight, or by increase the incentive to exercise for a player who has not reported data from his pedometer in the last week. Outside-the-game data can be data from a player's glucometer. If this data, for example, showed a player having high blood glucose in the evening, then the game can feed the player questions and incentives designed to help the player lower evening blood glucose levels. The invention can also provide immediate out-of-game rewards based on such data.

The invention can also adjust the video game based on in-game data entered by players. Inside-the-game data can be in the form of answers to questions. These answers might show that a player likes Italian food, but does not know much about carbohydrates. In response to such data, for example, the game gives the player more training about carbohydrates in Italian food, and directs fewer questions about carbohydrates in French food to that player.

The invention can transmit participant game data to medical professionals associated with supporting a participant who has a medical condition. This enables support workers to help assess self-management of a participant. In a video game with multiple players, a chat system enables communication among players. For multiple player video games, participants can be part of a team where adjusting the video game based on data from one participant affects all team members.

### Features and Advantages

A feature of the invention is daily play with daily rewards for playing in the game. Players that login to the game, enter data about their disease management, and play the game every day, are players that gain in-game and out-of-game rewards more quickly. Daily play follows the principle of intensive diabetes management, which calls for frequent contact between the patient and care provider. Encouraging daily play of the game also encourages players to manage their disease every day. This helps players meet their goals for blood glucose control, weight loss, dietary change, medication compliance, and exercise.

Another feature of the invention is directly connecting diabetes management with the immediate reward of winning a game. Current diabetes management does not have any immediate rewards. With current diabetes management attempts, patients can gain long term good health, but sticking themselves with a needle to test blood glucose, eating spinach instead of cookies, and trying to lose weight provide no immediate reward. In fact, the opposite is true, since most aspects of good diabetes self management require immediate pain (e.g. needle sticks) or forgone pleasure (e.g. not eating cookies). By providing immediate reward for good self management, the game assists diabetics in managing their disease. For example, when a player performs the needle stick required for the blood glucose test, the invention enables a player to score double points vs. the player who has not performed the needle stick and tested their blood glucose. In this way, the game provides immediate reward for taking the often difficult steps needed to manage diabetes and which previously forced a choice between short term suffering and long term reward.

Another feature of the invention is motivation with prizes. The game motivates a player to play by providing prizes for achieving certain scores in the game. Prizes are generally not connected directly to successful management of diabetes. It is possible to win prizes simply by playing the game well. Good diabetes management gives players advantages in the game, which helps them win prizes more quickly. Prizes motivate players to manage their disease. By making it possible to win the prizes without managing diabetes, the invention encourages diabetics to play the game, even if they do not believe they can manage their diabetes. This by itself is very important, because playing the game itself is the functional equivalent of joining a diabetes management program. By using prizes instead of reward payments for disease management, the game developer can address issues, such as low self efficacy, and can change good diabetes management from something that the patient is required to do into something the patient wants to do in order to for the patient to succeed in their game-related, prize-winning goals.

Another feature of the invention is providing out-of-game rewards based on game play. Such rewards are available to players that win without entering any medical data. Players are able to play a game relating to diabetes (or any other disease or medical condition) that provides rewards for successful play even if players do not take steps (other than playing the game itself) to manage their disease or report their self management efforts. Players are rewarded for success in the game with out-of-game rewards such as money or physical goods (such as diabetes test strips). While providing such out-of-game rewards, a game of the invention continues to suggest that self management and reporting provides benefits and that players can gradually be brought from a condition of no self management to a condition of good self management through use of the game.

Another feature of the invention is motivation with teams. The game groups players together according to preferences they express about diet, exercise, or other criteria. By grouping players into teams, the game provides additional motivation. People in general do not like to disappoint teammates with poor performance. Teams also provide positive motivation and encouragement. Using a virtual environment based around games facilitates grouping by out-of-game criteria such as enjoying swimming or cycling. Having this grouping occur inside a game environment creates a second common experience for group members, namely playing the game and the desire to win it. Both of these are powerful motivators.

The invention uses a multiple reward system to motivate diabetics in a target group to change unhealthy behaviors and/or add behaviors that have positive health effects to their lives. By using games, the invention adds several motivators, greatly increasing the chance that a diabetic will successfully manage the disease.

The invention removes the geographic and time constraints associated with community support through group meetings. Diabetics in virtually any location can participate in community support meetings. Community support can also be based on preferences expressed by the diabetics themselves and can use the Internet to connect diabetics with common interests.

The invention goes beyond a simple rewards system, and provides a sophisticated reward systems using Las Vegas style rewards (rewards that either come from direct competition in a game of skill or from competition combined with chance, or from pure chance), competitive rewards, and special awards that have social impact and impact on team play.

### BRIEF DESCRIPTION OF THE DRAWINGS

In the drawings, closely related figures and items have the same number but different alphabetic suffixes. Processes, states, statuses, and databases are named for their respective functions.

FIG. 1 is a high-level diagram of the operation of the game in team play.

FIG. 2 is a diagram showing interaction of game play and out-of-game actions.

FIG. 3 is a diagram showing integration of diabetes management processes into game play.

FIG. 4 is a diagram of game operation in a client-server environment.

### DETAILED DESCRIPTION OF THE INVENTION, INCLUDING THE PREFERRED EMBODIMENT

### Operation

In the following detailed description of the invention, reference is made to the accompanying drawings which form a part hereof, and in which are shown, by way of illustration, specific embodiments in which the invention may be practiced. It is to be understood that other embodiments may be used, and structural changes may be made without departing from the scope of the present invention.

The preferred embodiment of the invention is a game that operates in a client-server environment. Data about a user, such as a diabetic or player or other player-patient, including both past play and data that has been inputted in previous playing sessions, is stored on central servers. A database program, such as Oracle or Microsoft SQL Server, holds data objects on the server side. A secure log in is required both to protect the privacy of the patient and also to make cheating more difficult. This log in can use a password, a biometric device such as a thumb print reader, an encrypted smart card, or any other verification means.

In one embodiment, the game has options for a single participant to enter the participant's data, play the game, and gain the benefits of single player operation of the game. Embodied as a quiz game, the game runs through a web browser and is programmed in Adobe's Flash multimedia authoring program or another programming language compatible with a web browser.

In the preferred embodiment, the game has options for multiple participants to take action in the game simultaneously. Multi-player play is supported with voice chat and real-time typed chat. Optionally, games contain links to online bulletin boards so that players can discuss a given game.

Players access leader boards and other displays for viewing how players are scoring. Scoring displays can show comparisons with other teams, or with other individual players. Scoring displays optionally show players' progress in managing their disease and include information about future quality of life and health.

The game can have options for practice mode. In practice mode, points scored do not accrue towards any type of reward. In practice mode, links to educational content are generally more common than in regular play. The invention also provides games with links to health information that can be outside the game or in the game. For example, educational information can include printable recipes for healthier living.

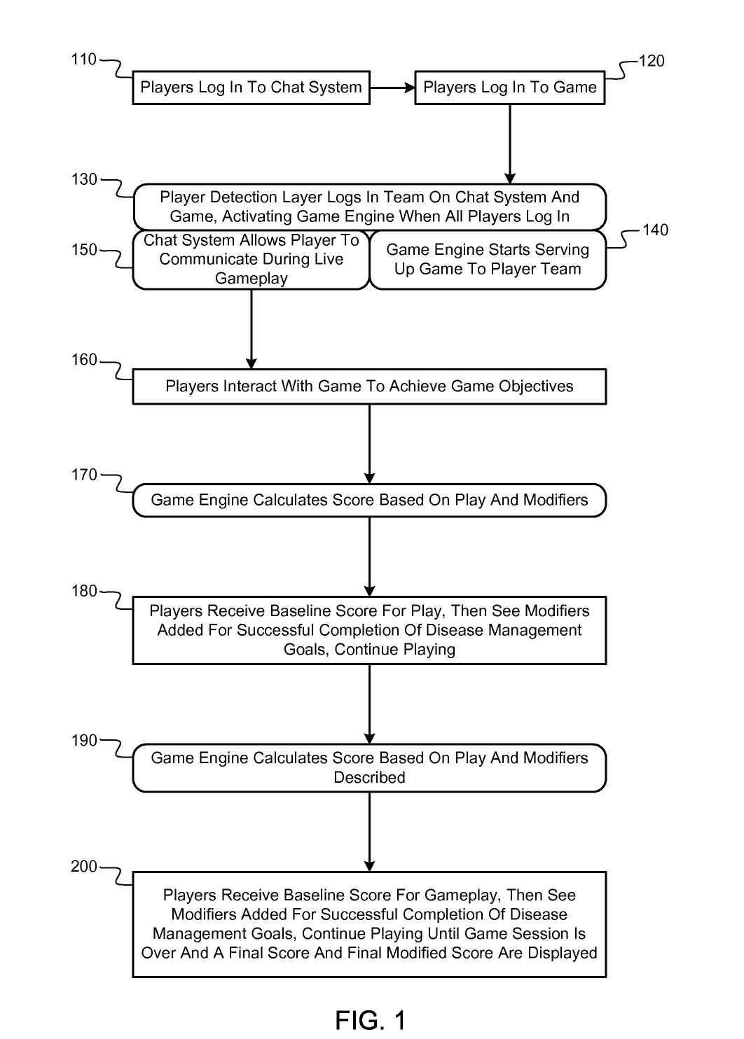

Referring now to the FIG. 1, a high-level diagram shows of the operation of the game in team play. Game players are grouped into teams. Each player has a unique login identification code for the game (120) and for an associated chat program (110). Chat can be typed chat or can be audio chat through a telecom bridge, IP teleconferencing program, IP chat program, or other means of providing a similar service. As the players join the game and chat, a player detection layer (130) logs player presence. The detection layer can be set to activate the game engine (140) when some or all of the players on the team log in, or set to activate at a particular time

The chat system (150) becomes operational immediately on arrival of the first player and preferably remains operational both before the game begins and after it ends in order to encourage player communication. Once the requirements of the detection layer have been met, a game engine (140) starts, which serves the game to players over the Internet, a LAN, or other online connection. The game can be any type of game, including, but not limited to, trivia, first person shooter, casual, or other.

Players then interact with the game through the screen on their PC, mobile device, or though their console and television (160). The game engine runs the game and logs their actions to generate a score (170). This score is modified by players completing of out-of-game actions that are considered helpful in managing their chronic disease. As players go through the game, they see, or are given access to, their baseline score within the game and their modified total score, which is calculated using a combination of their success in achieving disease management goals and their success in the game (180).

This process continues (190) throughout the multiplayer gaming session, with new score information being fed to players (180) until the game ends and players receive their final score, (200) including both game play score and modified score. The final modified score is the score used to calculate a team's performance versus other teams for ranking purposes and in total score terms for any prizes that are awarded for achieving a particular total score.

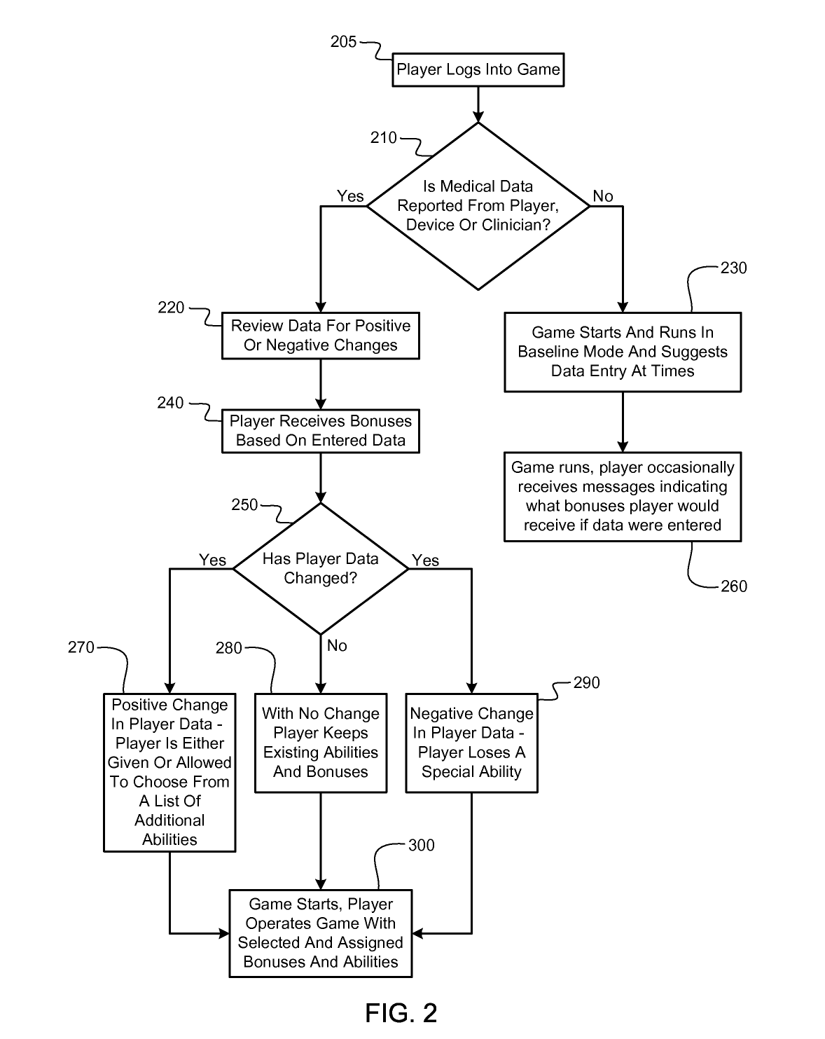

Referring to FIG. 2, a diagram shows interaction of game play and out-of-game actions. This system shows the method for integrating actions taken to manage diabetes with the play of the game. Player logs into the game (205) (this can be a log in for solo play or login for team play). The game gives players an option to report medical data (210). This option can be presented at login, or at other times during play of the game. The game can also retrieve medical data stored in another program or on another computer at this time, or at another time during the game. Key gates are the player logging in, which identifies who is playing, and a decision by the player or the game software to introduce some diabetes management data.

The game can draw data that is stored in a device such as a glucometer or pedometer. This data can be downloaded to the user's computer via a wireless connection, USB connection, or other device. When the player reports this information (210), it is uploaded to the server for storage and integration into the game play.

The integration process starts once the action in box 210 occurs, not necessarily at login (205). Login, however, is preferably a precondition to start the process, because login matches the diabetic with a certain set of player data that has been accumulating as the diabetic has been playing the game. If the player reports diabetes management data, then the game operates with diabetes management data integrated (220, 240, 250, 270, 280, 290, and 300). If the player does not report diabetes management data, then the game runs un-integrated (230, 260).

At box 230, the game runs in baseline mode. Bonuses and special abilities due to diabetes management are not available. Periodically, the game can inform the player that bonuses could be received if they added diabetes management data. At times, the game compares a player's actual progress in the game with the progress the player would have made if the player was reporting diabetes management data (260).

At box 220, the game receives player data. The player receives bonuses based on entered data (240). These bonuses are made apparent to the player, giving the player immediate positive feedback for entering the player's data. For example, in a quiz form of the game, game fields showing a possible score for correctly answering a question change from 10 points to 20 points as the player watches. Next, the game reviews the substance of the data entered (250). Additional bonuses and abilities are granted if the information is positive, such as losing weight (270).

If a player enters data that shows no change on certain measures of diabetes self care, then the player keeps existing abilities and bonuses, and can be allowed to change one or more of these for different abilities and bonuses, but the player is not granted additional abilities or bonuses. If the information is negative (290), for example weight gain or a decline in glycemic control, then abilities and bonuses can be taken away if the information indicates a decline in the quality of diabetes self management. A decline in self management does not mandate taking away bonuses or abilities. That is up to the game designer. After this process is complete (300), game play starts and the player operates the game with the selected and assigned abilities and bonuses in force.

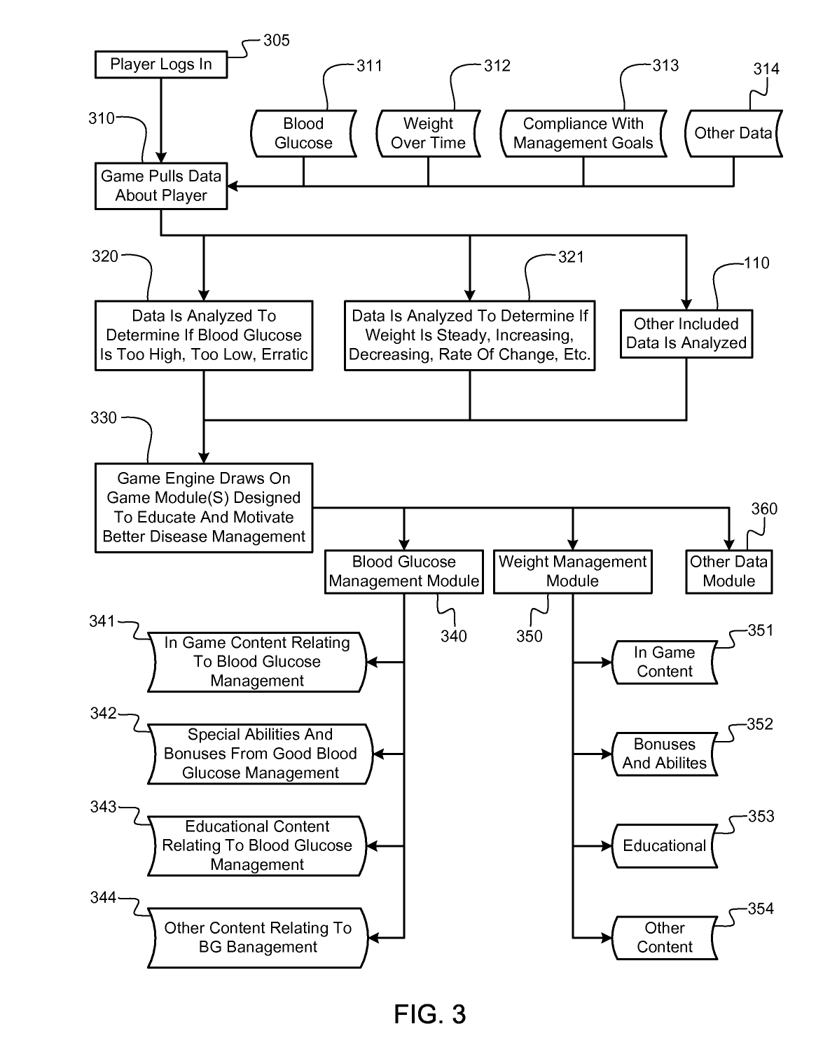

Referring now to FIG. 3, a diagram shows integration of diabetes management processes into game play. A player logs in (305). The game pulls data about the player (310). This data is stored data from previous play sessions, or stored medical data originating from a source such as the player's healthcare provider.

The data can be a history of blood glucose readings (311) as stored data from previous play sessions, or stored medical data originating from a source such as the player's healthcare provider. The data can be a history of the player's weight (312) as stored data from previous play sessions, or stored medical data originating from a source such as the player's healthcare provider. The data can be a history of compliance with diabetes management goals (313), which could include a record of the frequency of entry of other types of data into the game. For example, the game not only tracks blood glucose levels, but it also tracks when they are reported. The game can record or have access to other data such as medical data recorded in a clinical practice (314).

Blood glucose, weight, compliance, and other data are analyzed by an analytical engine within the game engine or an analytical engine accessed by the game engine for this purpose. Analytical engine looks at reported blood glucose levels at that moment and also over time (320). The game can show that blood glucose is consistently too high, or consistently too low, or erratic, or varies in relation to meals in ways that produce negative or positive patient outcomes. A similar engine performs the same function for weight (321). A plurality of similar engines performs the same function for additional categories of data (322).

Analysis returns to a primary game engine where the invention indicates how the game play should be modified to help diabetics manage their disease better (330). If indicated by analysis, then the game engine draws on a blood glucose management model (340).

The blood glucose management module draws on content prepared to help diabetics manage their disease (341). For example, in the quiz embodiment of the game, this content includes questions about food that are designed to help a diabetic learn healthy eating habits. In a railroad management embodiment of the game, this content might be a notice that a city would eat healthier if a rail line was built to outlying farms that grow apples. This content is available in either single player or multiplayer versions of the game.

The blood glucose management module also draws on a list of bonuses and abilities granted in a way that motivates the player to manage the disease (342). For example, in a quiz game this can consist of doubling points scored if blood sugar is reported, or the ability to change a wrong answer to a right one. In a race car game, motivation can come from faster tire changes by a pit crew, or higher octane gasoline.

The blood glucose module accesses additional educational material relating to blood glucose management (343). Such material can interrupt game play or be woven into game play. Such material can include voice-overs, written material, short movies shown within the game, or other content. Such material can link to information outside of the game, or send information to the player through a method such as email.

The blood glucose management module accesses other content relating to blood glucose management (344). Other content includes voice-overs, written material, short movies shown within the game, and so forth. The invention can link to information outside of the game, or send information to the player through a method such as email. Other content optionally includes virtual items such as avatars, fashion items for avatars, download of prize information to cell phones or smart cards for later redemption at a retail location or other location, electronic coupons, printable coupons, special prizes, or other materials from the game provider or from other sources.

Analysis returns to a primary game engine where the game indicates how the game play should be modified to help diabetics manage their disease better (330). If indicated by analysis, then the game engine draws on weight management model 350.

Weight management module 350 draws on content prepared to help diabetics manage their disease (351). For example, in a quiz embodiment of the game, such content can contain questions about food, or questions designed to suggest exercise options. These questions are designed to help a diabetic learn healthy eating habits. In an espionage game, the content could be focused on getting sugar or higher concentrations of fats hidden in foods that the opposing side would normally think of as healthy. This content can be available in either single player or multiplayer versions of the game.

Weight management module 350 also draws on a list of bonuses and abilities (352) granted in a way that motivates the player to manage a disease. For example, in a quiz game, such bonuses and abilities can consist of allowing a player to change one wrong answer to a correct answer each day if the player can reduce the player's weight by 5 lbs. In a game simulating a professional sport like football, exercise recorded with a pedometer can be used to modify game play so that in-game football players, controlled by the user, run faster.

Weight management module 350 accesses additional educational material relating to weight management (353). Such material can interrupt game play or be woven into game play. Such material can include voice-overs, written material, short movies shown within the game, or other content. Such material can link to information outside of the game, or send information to the player through a means, such as email, or a link to a video on hosted at a website.

Weight management module 350 accesses other content relating to weight management (354). Other content can include voice-overs, written material, short movies shown within the game, and so forth. The invention can link to information outside of the game. For example, the game can receive information from a pedometer or send information to the player through a means such as email or an outbound reminder call to a mobile phone. Other content optionally includes virtual items such as avatars, fashion items for avatars, download of prize information to cell phones or smart cards for later redemption at a retail location or other locations, electronic coupons, printable coupons, special prizes, or other materials from the game provider or from other sources.

Analysis then returns to a primary game engine where the invention indicates how the game play should be modified to help diabetics manage their disease better (330). If indicated by analysis, then the game engine draws on a plurality of management models designed to assist diabetics in managing their disease (360). These modules can be sub processes relating to blood sugar, medication regimen, metal health issues such as depression, self efficacy, or social issues such as group dynamics or how to politely refuse food dangerous to diabetics when a well meaning friend offers such food.

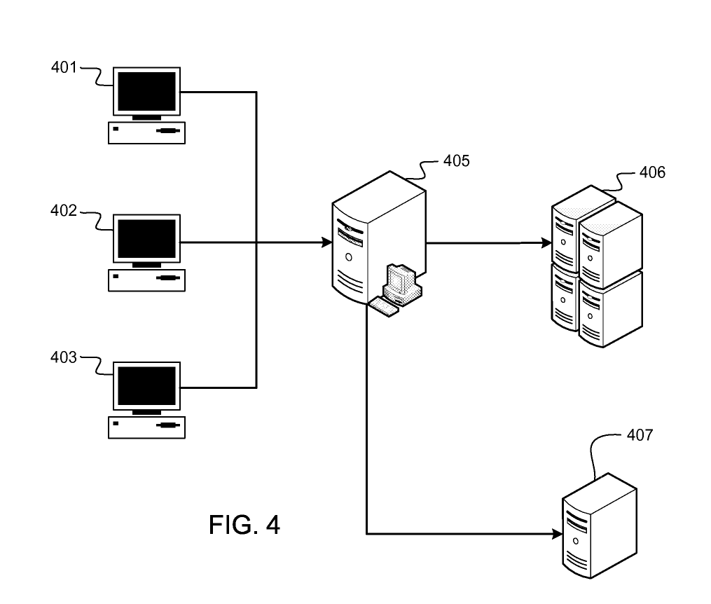

Referring now to FIG. 4, a diagram shows operation of the game in a client server environment. Client computers 401, 402, and 403 connect to authentication server 405 via an IVPN or other network. A player identifies himself and sends to authentication server 405 either a login ID and password, or other method of secure login such as a biometric security device. Authentication server 405 then connects a player's client computer with game server 406 commencing play of a video game.

If a player is playing in a team play session or other multiplayer session, then the player can also be connected to chat server 406 so that the player can engage in voice chat with other members of a team, or other players of the game, while engaged in game play. After the player has been authenticated and connected to the game server, the client may send data entered about the player's blood glucose level(s), weight and other attributes, important to diabetes management, on the players' computers 401, 402, 403 to the server. This data is used in the operations described in FIG. 2.

During operation of the game, game server 406 sends instructions to the client program on the players' computers 401, 402, 403. These instructions can activate existing files on the players' computers. Game server 406 can also send data to the client including, but not limited to, additional questions, game updates, other changes to game play, or new audio files.

### OTHER EMBODIMENTS

The present invention can take many different forms and be resident on multiple platforms. In one embodiment, the game is a railroad game, where good diabetes management gives access to better engines, stronger bridging materials or better construction techniques. In another embodiment, the game is a multiplayer car race game, where good diabetes management practice grants access to higher octane fuel, faster tire changes, or other advantages in the game. In another embodiment, the game is a variant on poker or other card games, where players gain access to advantages such as more privileges, different cards, additional cards, or other advantages in the game due to good diabetes management.

The present invention can provide education through means other than questions and quizzes. In one embodiment, game players play human (or humanoid) avatars and are required to “feed” the avatars. In this embodiment, the process of developing diabetic complications can be accelerated so that eating a dangerous diet produces negative effects on the avatar within a short period of time such as minutes, hours, or days.

In another embodiment, the present invention provides education by using the cause and effects of diet, exercise, and medication as part of a combat system. Players could attack avatars of other players by feeding those avatars food that causes hyperglycemia, or denying them food in a way that causes hypoglycemia. Players could aid their friends by providing healthy food, or insulin or other medications. This embodiment can use a combat system where players form teams with dedicated offensive, defensive and healing rolls on the team.

In another embodiment, the present invention provides education by requiring a railroad system to transport good nutrition and medications to cities and towns to keep them healthy. Destinations serve as analogs for human diabetic patients, with similar medication, nutritional and exercise means. Players meet these needs while facing the enjoyable challenge of running the railroad company.

In another embodiment, the present invention provides a game for the diabetic take on the role of an endocrinologist, dietician, diabetes educator or all three. Players then attempt to manage the diabetes of a number of virtual patients and, in the process, they learn about their own diabetes. For example, for a player in the role of a clinician treating diabetes, the reward component for good diabetes management can be the use of additional medications, access to more support, and access to different roles. In this embodiment, checking blood sugar regularly can provide access to the dietitian making it more likely that the player will successfully get virtual diabetic patients to eat the right foods.

In another embodiment, the present invention can be used to motivate behavioral change in ways that are designed to manage pre-diabetes. Pre-diabetes is a set of indicators such as obesity and mild resistance to insulin which are often pre-cursors to the development of diabetes.

In another embodiment, the present invention can be used to motivate behavioral change in ways that are designed to manage hypertension.

In another embodiment, the present invention can be used to motivate behavioral change in ways that are designed to manage other diseases, medical conditions, or non-medical situations.

In another embodiment, the present invention can be used to motivate behavioral change in ways that are designed to promote wellness in individuals who have no current health problems but can benefit from wellness programs that have motivational factors beyond a simple desire for better (or good) health.

In another embodiment, the present invention can be used to motivate behavioral change in ways that are designed to assist patients with psychological disorders such as anxiety or agoraphobia.

In non-medical situations, the game is used to encourage behaviors that are of value to a corporation, such as increasing interdepartmental communication. In another non-medical situation, the present invention can be used to improve social cohesion at a school.

In another embodiment, the present invention can be used to motivate behavioral change in ways that are designed to make individuals in a corporation or other organization function more effectively in their jobs. In such an embodiment, users can be provided with motivators designed to improve appropriate communication within the corporation. Additionally, users can be provided with educational objects within the game designed to motivate behavior discouraging inappropriate communication within a corporation such as, for example, emails about free kittens to be given away by someone in accounting.

In another embodiment, the present invention can be used to motivate behavioral change in ways that are designed to encourage individuals using one service or product from a first vendor, to try additional products and services. In this embodiment, a user of a first type of car can be provided with options to try out a second type of car within the game to learn about different cars.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A method for improving self-management of a medical condition, the method comprising:
providing a video game electronically accessible to a participant and designed for use by a participant having a medical condition, wherein said video game has predefined game rules and game objective;
accessing medical data of the participant, said medical data including participant-submitted data relating to self-management of the medical condition;
prompting the participant to perform an out-of-game self-management activity associated with the medical condition;
providing an interface for receiving medical data associated with the out-of-game self-management activity; and
adjusting the video game based on medical data associated with the out-of-game self-management activity.

2. The method of claim 1, wherein medical data indicating negative progress with self-management of the medical condition, negatively affects the video game.

3. The method of claim 1, further comprising displaying educational material in the video game about the medical condition.

4. The method of claim 1, further comprising transmitting participant game data to medical professionals associated with supporting a participant having a medical condition.

5. The method of claim 1, further comprising selecting an out-of-game reward based on game play of a participant.

6. The method of claim 1, wherein the medical condition is diabetes.

7. The method of claim 1, wherein the medical condition is diabetes, and further comprising receiving blood glucose data automatically through a blood glucose device.

8. A method for improving self-management of a disease, the method comprising:
providing a video game electronically accessible to multiple participants and designed for use by participants having a medical condition, wherein said video game has predefined rules and objective, and wherein the video game is networked thereby providing simultaneous play to the multiple participants;
identifying active participants of the video game;
providing a chat interface for the multiple participants to communicate with each other during live play;
accessing medical data of the multiple participants, said medical data including participant-submitted data relating to self-management of the medical condition;
prompting participants to perform an out-of-game self-management activity associated with the medical condition;
providing an interface for receiving medical data from the out-of-game self-management activities of the multiple participants; and
adjusting the video game based on medical data associated with the out-of-game self-management activity.

9. The method of claim 8, wherein adjusting the video game includes modifying participant scores, wherein modifying scores affects multiple players.

10. The method of claim 8, further comprising selecting an out-of-game reward based on game play of a participant.

11. The method of claim 8, wherein medical data indicating negative progress with self-management of the medical condition, negatively affects the video game.

12. The method of claim 8, wherein the video game includes team play and wherein medical data of a participant team member affects the video game for all participant team members.

13. The method of claim 8, wherein the medical condition is diabetes.

14. The method of claim 8, wherein the medical condition is diabetes, and further comprising receiving blood glucose data automatically through a blood glucose device.

15. A computer-readable recording medium on which is recorded a video game program for improving self-management of a medical condition, the video game program causing a computer to:
provide a video game to a participant, wherein the video game is designed for use by a participant having a medical condition, wherein said video game has predefined game rules and game objective;
access medical data of the participant, said medical data including participant-submitted data relating to self-management of the medical condition;
prompt the participant to perform an out-of-game self-management activity associated with the medical condition;
provide an interface for receiving medical data associated with the out-of-game self-management activity; and
adjust the video game based on medical data associated with the out-of-game self-management activity.

16. The computer-readable recording medium of claim 15, further comprising the video game program causing a computer to, provide the video game to multiple participants for simultaneous game play.

17. The computer-readable recording medium of claim 15, further comprising the video game program causing a computer to, adjust the video game based on medical data received from a third-party and associated with supporting a participant having a medical condition.

18. The computer-readable recording medium of claim 15, wherein the video game requests medical data from a participant on a daily basis.

19. The computer-readable recording medium of claim 15, wherein the video game provides educational material.

20. The computer-readable recording medium of claim 15, wherein the medical condition is diabetes.
